(19) United States
(12) Patent Application Publication
(10) Pub. No.: US 2026/0127553 A1
(43) Pub. Date: May 7, 2026

(54) EMAIL INTERFACE WITH DYNAMIC HEADERS

(71) Applicant: Mark Lambert, Tarpon Springs, FL (US)

(72) Inventor: Mark Lambert, Tarpon Springs, FL (US)

(21) Appl. No.: 18/938,164

(22) Filed: Nov. 5, 2024

(51) Int. Cl. G06Q 10/107; G06F 3/0481; H04L 51/212

(52) U.S. Cl. CPC G06Q 10/107; G06F 3/0481; H04L 51/212

(57) ABSTRACT

The technology creates dynamic headers to organize electronic messages in a message client software application on a user device. The technology involves configuring criteria for headers to dynamically separate messages into groups based on metadata such as time parameters, sender, recipients, and urgency. Headers are generated and inserted into the user interface to separate messages that meet the criteria from those that do not. The criteria can be reconfigured, causing the headers and associated messages to be dynamically repositioned. The technology can reconfigure headers to dynamically modify display of the messages. The technology supports user input for criteria configuration and utilizes generative AI models to process metadata and generate headers, enhancing the organization and presentation of electronic messages.

### BACKGROUND

An email client is a software application that is installed on a user's device (e.g., mobile phone, desktop computer, laptop computer). Depending on the email client provider (e.g., Gmail, Outlook, Yahoo), the graphical user interface (GUI) may look and feel different. However, many email graphical user interfaces function similarly. For example, email clients have a GUI that enables users to read, compose, and organize emails. The GUI includes the inbox, message pane, and compose pane.

A mailbox such as an inbox serves as the primary interface for viewing and managing received emails. Each email entry in the inbox is displayed with the sender's name, the message subject, and the date of receipt. Emails contain metadata that enables the GUI to accurately display detailed information about the sender's address, subject line, and timestamp, which facilitate proper organization of emails. For example, a user can quickly identify and prioritize emails from important contacts by recognizing the sender's address, sort emails by subject line to group related conversations, and use the timestamp to manage and respond to urgent messages first.

Upon selecting an email in the inbox, the message opens in the message pane, allowing the user to read the content and respond using various available commands. By selecting the Compose or New button from the inbox, the user can open the compose pane to create an email message. In this pane, the user must enter the recipient's email address and enter the subject. The user has the option to upload attachments, such as photos and documents, and apply formatting to the message.

### BRIEF DESCRIPTION OF THE DRAWINGS

Reference will now be made, by way of example, to the accompanying drawings which show example embodiments of the present application, and in which:

FIG. 1 illustrates a graphical user interface (GUI) of a mobile device 100 displaying a list of email messages or related graphical objects.

FIG. 2A illustrates a GUI of a user device displaying an email mailbox integrated with the dynamic header system depicting one dynamic header.

FIG. 2B illustrates a GUI of a user device displaying an email mailbox integrated with the dynamic header system depicting two dynamic headers.

FIG. 2C illustrates a GUI of a user device displaying an email mailbox integrated with the dynamic header system depicting four dynamic headers.

FIG. 3 illustrates multiple variations of a dynamic header, each with modified components to change the text presented on the header.

FIG. 4 illustrates a GUI of a user device displaying an email mailbox integrated depicting a calendar view for modifying a component of a header.

FIG. 5 illustrates a GUI of a user device that displays one or more headers with areas that can be customized through colors.

FIG. 6 is a diagram that depicts structures and processes of the dynamic header system.

FIG. 7 is a flowchart illustrating a process for modifying components of dynamic headers configured to organize electronic messages presented in a message client software application at a user device.

FIG. 8 is a flowchart illustrating a process for creating dynamic headers configured presented in a message client software application at a user device.

FIG. 9 is a block diagram that illustrates a user engaged with an email application using the disclosed technology through a mixed reality system.

FIG. 10 is a block diagram that illustrates technology stacks of a mixed reality platform that can administer a session of the disclosed technology on a near-to-eye display system.

FIG. 11 is a block diagram of a transformer neural network, which can be used in examples of the present disclosure.

FIG. 12 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology includes a system that can organize electronic messages (e.g., email) based on their content or metadata (e.g., sender's name, the message subject, and the date of receipt) in a mailbox with dynamic headers. The dynamic headers are headlines generated by a message header system that can organize and categorize electronic messages in a mailbox based on specific calendar periods, such as day of the week, month, year, date of the day, today, last week, last month, and last year. In one example, users can customize their electronic message viewing experience by selecting which calendar periods they want the headers to display. In another example, a user can choose to have headers appear above emails received today, last week, and last month, and/or a user can choose to display headers only at the most recent email of each selected period. The message header system can allow users to better organize and navigate their mailbox, thus making it easier to locate and manage emails based on their particular criteria.

The message header system can generate dynamic headers by analyzing the metadata of each email, specifically the date and time of receipt. Once user preferences are set, the message header system can determine the appropriate calendar periods and generate dynamic headers accordingly. The dynamic headers are then displayed above the emails that are within the respective periods. For example, if a user selects “last week” as a calendar period, a header labeled “last week” will appear above the first email received in the previous week. The email header system can thus enhance the organization of the inbox and the user's ability to quickly identify, and access emails based on user's calendar period preference. The dynamic nature of the headers can ensure that the headers adapt to the user's preferences and the changing content of the mailbox, providing a more intuitive and efficient message management experience.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

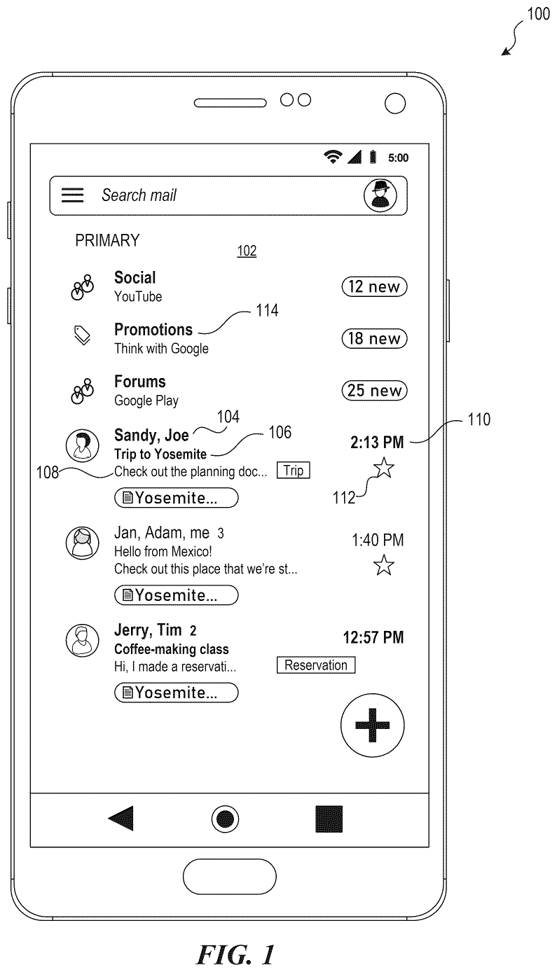

FIG. 1 illustrates a user interface (UI) of a mobile device 100 displaying a list of email messages. The disclosed technology can organize the email messages by using the dynamic header system disclosed herein. The UI 102 is displayed on a screen of the mobile device 100, showing a typical email mailbox. The UI 102 includes a list of graphical objects that represent email messages. Each email represented by a message preview includes the sender's name 104, subject line 106, a snippet of the message content 108, a timestamp 110 indicating when the message was received, and a priority indication 112 (e.g., urgent). The UI 102 includes graphical objects linked to groups 114 of emails related to common topics.

The UI 102 displays the current interface that users navigate to read electronic messages. As described below, integrating the dynamic header system into a mailbox will improve the user experience. The dynamic headers provide a clear and organized structure to the inbox, making it easier for users to locate and manage their emails. By categorizing emails into distinct criteria, users can quickly identify and access messages based on the values of the criteria (e.g., receipt dates). The headers adapt dynamically to the user's preferences and the changing content of the mailbox, ensuring an intuitive and efficient message management experience. In another embodiment, the interface displaying the electronic messages can be of a desktop, tablet, laptop, etc.

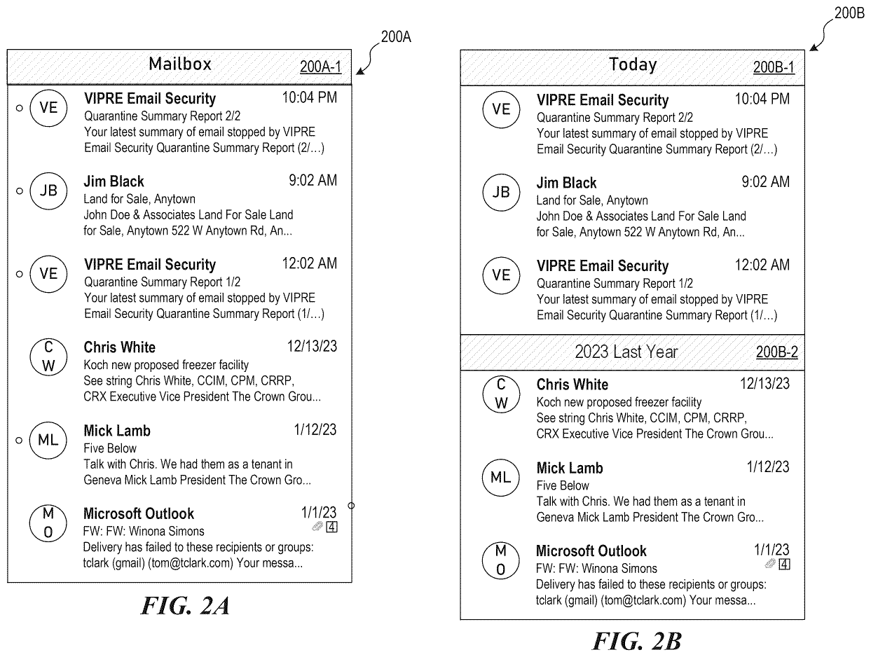

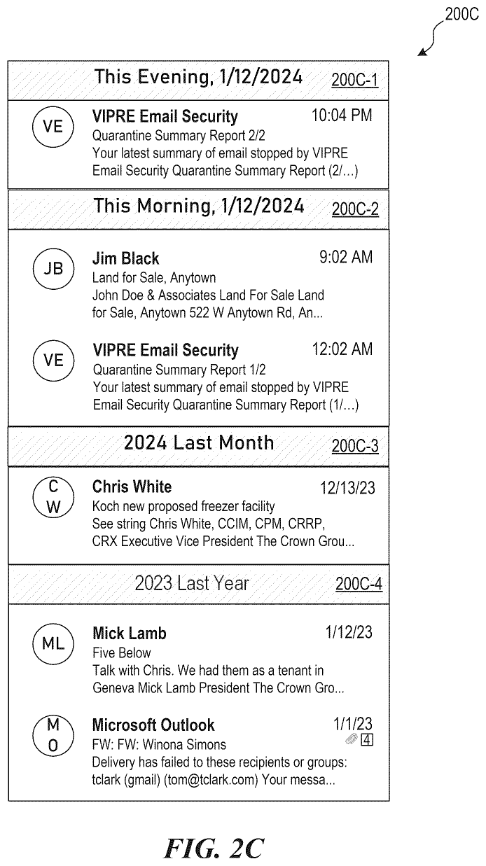

FIG. 2A illustrates a UI 200A of a user device, displaying an email mailbox integrated with the dynamic header system and depicting a dynamic header 200A-1. Initially, the dynamic header 200A-1 is labeled as “mailbox,” indicating the default state before any customization is applied by the user based on user-defined criteria. Alternatively, the criteria can be defined automatically or based on an artificial intelligence (AI) output as detailed later. In this default state, the dynamic header 200A-1 displays the emails in chronological order based on an email's timestamp, with the most recent emails previewed at the top. For example, the UI 200A with dynamic header 200A-1 depicts six emails in chronological order that are timestamped (e.g., 10:04 PM, 9:02 AM, 12:02 AM, 12/13/23, 1/12/23, 1/1/23) descending from the top when the user received that specific email. As shown, the most recent email, “VIPRE Email Security,” is located at the top of the email list with a timestamp of 10:04 PM. Meanwhile, the email, “Microsoft Outlook,” is located at the bottom of the email list with a timestamp of 1/1/23. However, once the user configures the dynamic header system, the interface will display different headers that separate emails based on user-defined parameters that define an emails time period such as “Today”, “Last Year”, “Last Month, etc.

FIG. 2B illustrates a UI 200A of a user device, displaying an email mailbox integrated with the dynamic header system depicting dynamic header 200B-1 and dynamic header 200B-2. The UI 200A displaying multiple dynamic headers is a result from a user updating the criteria of the default dynamic header (e.g., “Mailbox”). For this example, the user customized the email mailbox to display two dynamic headers with different values for a criterion corresponding to a time parameter. In particular, the dynamic header 200B-1 displays the value “Today” of the time parameter. Within the section bordered by the “Today” header, emails are shown with timestamps such as 10:04 PM, 9:02 PM, and 12:02 PM, indicating that the emails were received at specific times on the current day (e.g., today). This customization allows the user to quickly identify, and access emails received on the same day.

In the example of UI 200B, the dynamic header 200B-2 is customized by the user to display emails that satisfy the criteria matching “2023 Last Year.” Within the section bordered by the “2023 Last Year” header, emails are shown with timestamps such as 12/13/23, 1/12/23, and 1/1/23, indicating that the emails were received in the previous year, specifically 2023. The customization allows the user to separate and view emails from different dates of the current calendar period or previous calendar periods, such as years (e.g., 2024, 2023, 2022), based on criteria defined by a user or a machine (e.g., AI system)

FIG. 2C illustrates a UI 200C of a user device, displaying an email mailbox integrated with the dynamic header system depicting dynamic header 200C-1, dynamic header 200C-2, dynamic header 200C-3 and dynamic header 200C-4. The UI 200C thus displays four dynamic headers, each based on criteria values, demonstrating the flexibility and customization capabilities of the system.

The dynamic header 200C-1 is customized by the user to display emails received during the evening of Jan. 12, 2024. The dynamic header 200C-1 allows the user to quickly access and review emails that were received in a specific time frame of the current day. Within the section bordered by the header showing “This Evening, 1/12/2024,” an email is shown with a timestamp of 10:04 PM. As a result of the criteria, the dynamic header system only separated one email for the user. This precise categorization helps the user to efficiently manage and prioritize emails received in the evening, ensuring that current message is not overlooked.

The dynamic header 200C-2 is customized to display emails received during the morning of Jan. 12, 2024. The dynamic header 200C-2 provides a clear separation of emails based on the time of day, allowing the user to focus on messages received in the morning. Within the section bordered by the header showing “This Morning, 1/12/2024,” emails are shown with timestamps of 9:02 AM and 12:02 AM. As a result of the criterion, the dynamic header system separated two emails, from among the other emails, for the user. This precise categorization helps the user to efficiently manage and prioritize emails received in the morning, ensuring that emails received earlier in the day are not overlooked.

The dynamic header 200C-3 is customized by the user to display emails received in the previous month of the current year, 2024. The dynamic header 200C-3 helps the user to organize and review emails from a broader time frame, providing a monthly overview. Within the section bordered by the header showing “2024 Last Month,” an email is shown with a timestamp indicating the date 12/13/23. As a result of the criteria, the dynamic header system only separated one email for the user. This precise categorization allows the user to efficiently manage and reference emails from the previous month, facilitating better tracking of ongoing communications.

The dynamic header 200C-4 is customized by the user to display emails received in the previous year of 2024. The dynamic header 200C-4 provides a clear separation of emails based on the year 2023, allowing the user to easily access and review older messages. Within the section bordered by the header showing “2023 Last Year,” emails are grouped with the receipt dates 1/12/2023 and 1/1/2023. As a result of the criteria, the dynamic header system separated two emails that satisfy the criteria into a group. This precise categorization allows the user to efficiently manage and reference emails from the previous year of the current calendar period, ensuring that past email communications are displayed in the UI 200C and are readily accessible.

The technical framework of the dynamic header is thus configured to dynamically group email messages within an email client software application for display on a user device. In particular, the dynamic header system can configure criteria via a criteria-defining module that can be used to separate email messages into groups under a header that satisfies the specific values for the criteria. The dynamic header system extracts metadata of the email messages via a data-extraction module. The dynamic header system processes the extracted metadata (e.g., timestamps) of the email messages via an algorithm and/or a generative AI system to determine whether the metadata satisfies the criteria values of headers. For example, the dynamic header system can generate headers with different values for a time parameter, which serves as the criterion for grouping messages. The metadata of each message is analyzed to determine the header to which the message belongs. The dynamic header system can dynamically insert the headers into the interface of the user device or group the electronic messages in accordance with headers having matching criteria values. Additionally, the dynamic header system allows the user or the generative AI system to reconfigure the criteria via the criteria-defining module. Reconfiguring the criteria causes the headers and associated messages to be dynamically modified in response to changes in the criteria values. The criteria reconfiguration ensures that the organization of messages remains flexible and responsive to the user's needs.

The relationship among the headers is established by determining how the metadata of the email messages satisfy the different values of a common or different criteria. For example, the multiple headers generated and displayed at UI 200C have the same criteria, but with different values. In this case, a common criterion for associating email messages to the dynamic header 200C-1 and the dynamic header 200C-2 is the time parameter. However, the time parameter includes different values associated with different time ranges (e.g., morning, afternoon, evening). The dynamic header 200C-1 and the dynamic header 200C-2 each contain emails that were grouped based on a time parameter. One time parameter has a value of “10:04 PM” for the email “VIPRE Email Security.” A second time parameter has a value of 9:02 AM for the email “Jim Black.” A third time parameter has a value of 12:02 AM for the second email “VIPRE Email Security.” The email associated with the “evening” time parameter (10:04 PM) is grouped under the dynamic header 200C-1. The emails associated with the “morning” time parameters (12:02 AM and 9:02 AM) are grouped under the dynamic header 200C-2.

The dynamic header system allows users to specify a number of times that a time-based component (e.g., year, month, day, and date) is present in headers, regardless of how many emails are associated with the component. As such, a component could appear in the email stack N times, which could span more than N consecutive instances for that time component. For example, the system can be configured to display the year component for every year present in the email stack, a maximum M times of a month component, which can span more than M consecutive months if some months are without emails, the day component up to a maximum D times, and so on.

The dynamic header system allows the user to customize the header content format. The user can rearrange the presentation of header information according to the user's preferences. For example, the header content can be formatted in various ways such as “2023, Last Year,” “Last Year 2023,” “Year 2023,” or even more descriptive formats such as “Really Old.” The format of the header content is customized via the criteria-defining module that configures the criteria for the headers. By processing metadata of the email messages, the system dynamically generates and inserts headers into the user interface, ensuring that messages are organized according to the specified criteria. The flexibility in header content format allows users to tailor the display of headers to better suit the user's organizational needs and personal preferences.

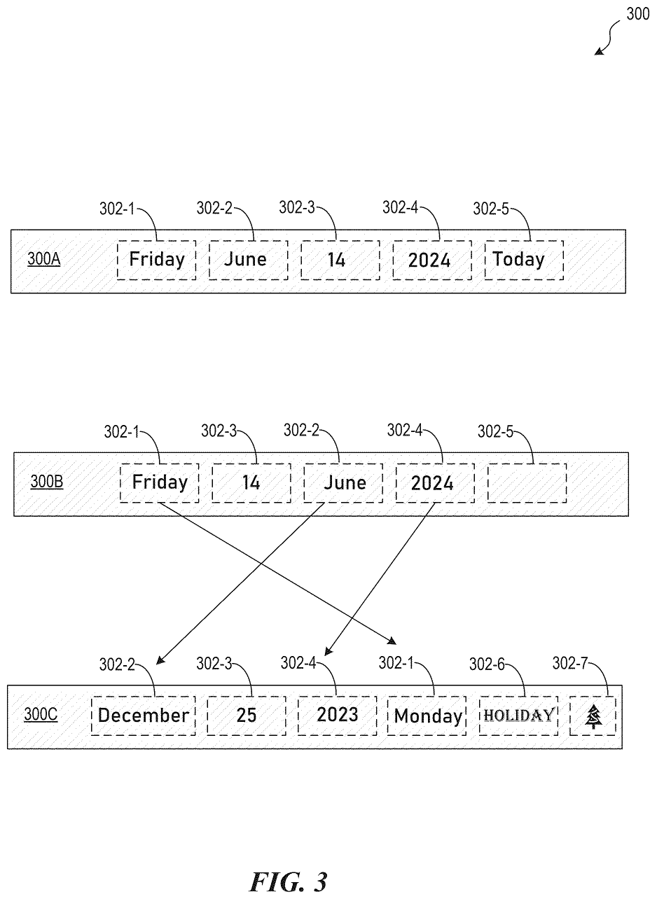

FIG. 3 illustrates a dynamic header 300 with one or more altered components that presents multiple header variations (e.g., 300A, 300B, 300C) based on the criteria. The components correspond to an array of cells embedded in the headers that are configured to contain respective values of criteria that are displayed in the header. As shown, the components are linearly arranged across the length of a header, and the combination of the components depicts a date in a particular format. A user or an automated system can adjust the header components to meet specific criteria. Modifying these components updates the text displayed on the header, and reorganize emails grouped under the header according to the modified criteria. The adjusted header is designed to dynamically group messages received via a server that includes modules (e.g., criteria-definition, data-extraction) integrated with an email client for presentation on the user device.

The components of a header can be rearranged, relocated, removed, and exchanged for different types. Examples of types include a day, month, year, etc. The types can have different formats. Examples of the formats include numerical or text values (e.g., “10” or “October”). The values of the components are adjusted to meet specified criteria. For example, the dynamic header 300A has five components with customizable values (e.g., strings, integers). Component 302-1 contains a textual value for the day of the week (e.g., “Friday”), component 302-2 contains a value for a textual month name (e.g., “June”), component 302-3 contains a numerical value for a day as (e.g., “14”). Further, component 302-4 contains a numerical value for a year (e.g., “2024”), and component 302-5 contains a textual time expression (e.g., “Today”). As a result, the dynamic header 300A presents the combination of components as the date “Friday Jun. 14, 2024 Today”and categorizes all emails that satisfy the criteria of that date.

The dynamic header 300B has the same component types as the dynamic header 300A, including identical values for components 302-1 through 302-4. However, the value for the time expression of component 302-5 is absent in the dynamic header 300B. Thus, the component 302-5 of the dynamic header 300A was selected and its value was removed. Hence, the components of the dynamic header 300A are reconfigured in dynamic header 300B, omitting the value in component 302-5 (i.e., “Today”) to thereby show “Friday Jun. 14, 2024.”

In another example, modifying a component in the dynamic header results in the dynamic header repositioning itself to another location in the email stack. The new location is above the group of emails that satisfy the defined criteria. For example, the component “2024” in “Friday Jun. 14, 2024 Today” can be modified to “2023.” In response, the dynamic header is updated to display “Wednesday Jun. 14, 2023 Last Year” and repositions lower in the email stack to label and group all emails that of the year 2023. The user also has the option to reverse the email stack's chronological order to have last year's emails show up first and the current years emails reposition to the bottom (e.g., reverse chronological order).

The system provides flexibility in displaying or segmenting components such as “Today,” “Last Week,” “Last Month,” and “Last Year.” For example, the users can choose whether to display these components and can further drilldown into sub-components. In one example, a user separates a component for “Today” into “Morning” or “Evening” to provide a granular organization of emails. Therefore, the user can organize emails that pertain to a specific time of day (e.g., morning, afternoon, evening) instead of an entire day.

The dynamic header 300C reorders components of the dynamic header 300A and replaces a component with another type. In particular, the component 302-2 (month type) is moved to the leftmost position, the component 302-4 (year type) is moved left one position, and the component 302-1 (day-of-week type) is moved three positions to the right. Lastly, the component 302-5 (name of day type) has been replaced by component 302-6 (significance of day type). The components 302 are thus reordered and replaced to satisfy criteria for the dynamic header 300C. The dynamic header 300C also illustrates that the values for each component can have a custom font and/or custom font size. For example, the component 302-6 has a different and smaller font than the other components with textual values (e.g., 302-1, 302-2, 302-3, 302-1). Furthermore, the dynamic header 300C illustrates that the value for a component can also be a symbol or emoji. For example, the component 302-7 contains a Christmas tree. The components 302 are thus customized to satisfy criteria for the dynamic header 300C.

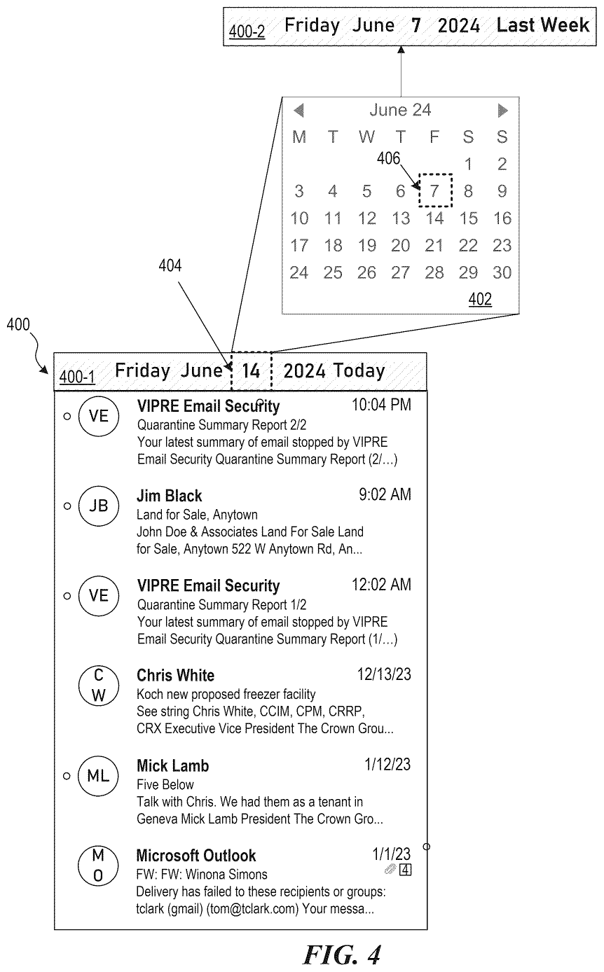

FIG. 4 illustrates a GUI 400 of a user device displaying an email mailbox integrated with a dynamic header system. The GUI 400 presents a calendar widget 402 that provides for customizing a component of a dynamic header 400-1. Specifically, a user or machine can interact with a selected component on the header through an input, which causes the GUI 400 to present a widget or other control that provides selectable types, formats, or values for the component. The interaction with the component can be facilitated through various inputs such as touch sensors, mouse clicks, etc. The user can thus select any component on the header to modify its type, format, or value for that specific component.

Dynamic headers serve as labels that categorize and separate emails based on specific criteria. As shown, the user can modify a component to reconfigure the dynamic header 400-1 to group emails that are one-week old messages. In particular, the user selected the day-type component that has a numerical value 404 of “14.” After selecting the component, the calendar widget 402 is presented dynamically, next to or overlaying (not shown) the GUI 400. The user selects a numerical value 406 of “7” to specify the new day of interest from the calendar widget 402, which updates the value of the selected component in the dynamic header 400-1. The dynamic header system processes the input (e.g., changing the numerical value from 14 to 7) and reconfigures the dynamic header 400-1 to dynamic header 400-2. The dynamic header 400-2 now displays “Friday Jun. 7, 2024 Last Week.” Modifying one component can result in the automatic update of other components For example, changing the numerical value for the day of the week by 7 causes the textual reference to a time from 400-1 (e.g., “Today”) to 400-2 (e.g., “Last Week”). The dynamic header 400-2 now serves as a label that categorizes and separates emails based on “Friday Jun. 7, 2024 Last Week.”

In some embodiments, the dynamic header components are selectable and once selected (e.g., touch, mouse click) the user is presented with a control such as a widget (e.g., drop-down list, text field with input value, slide bar) that allows the user to change the criteria. For example, the calendar widget 402 or other control is rendered dynamically through a combination of client-side and server-side processes. As shown in FIG. 4, when the user selects a component, such as the numerical value 404 of the day “14,” a client-side script is triggered to capture the user's input. This script sends a request to the server, which processes the request by fetching relevant data, such as available dates and user preferences, from a database. The server then responds with the necessary data in a structured format. Upon receiving the server's response, the client-side script dynamically updates the GUI to display the calendar widget 402 using a front-end framework, allowing for real-time updates without a full page reload. The user can then select a new date from the dynamically rendered calendar widget 402, and the selection is captured by another client-side script. The script updates the component of the dynamic header accordingly, ensuring that the header reflects the new date selection, such as changing from “Today” to “Last Week.” This interaction between client-side and server-side processes ensures a responsive calendar view 402 and component value modification for the user.

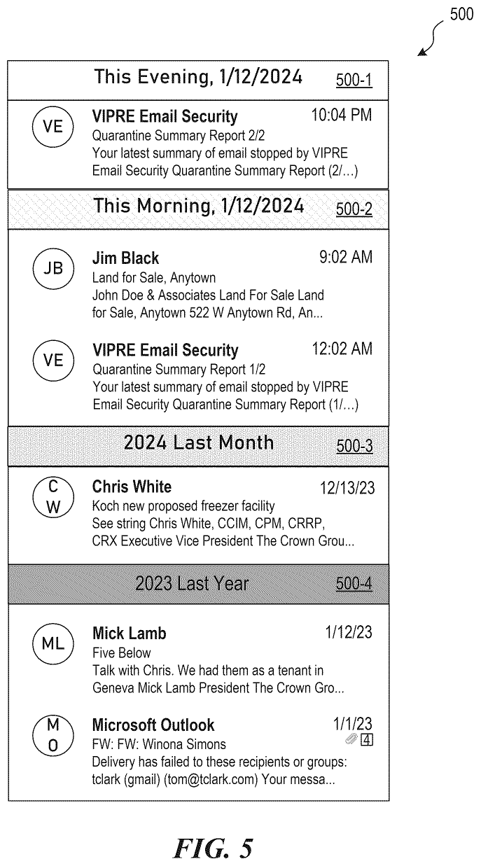

FIG. 5 illustrates a GUI 500 of a user device that displays an email inbox incorporating a dynamic header system. The illustration shows one or more headers with areas that can be customized through colors (e.g., shading). The colors serve as a visual indicator of criteria alongside textual information (e.g., “This Evening, 1/12/2024”), aiding users in differentiating between various dynamic headers 500-1, 500-2, 500-3, and 500-4 (collectively referred to as “headers 500”) and the grouped emails associated with each header. The headers 500 are shown in a gradient range from lighter to darker shades to ensure clear visual separation among the customizable headers.

As shown, dynamic header 500-1 has been customized by a user to present a white background. Dynamic header 500-2 is customized to display a light gray background, while dynamic header 500-3 features a medium gray shade as its background. Finally, dynamic header 500-4 has the darkest gray background chosen by the user. Users can customize these header colors through a client-side script that enables them to select their preferred hues or shades from the GUI. When a user chooses a specific shade for any given criterion, this input is captured by the client-side script, which then updates the header's properties accordingly. Front-end frameworks that support real-time GUI updates facilitate this interaction, ensuring the selected shades are promptly applied to the dynamic headers 500. This ability to customize header shading improves the user's capability to visually organize and manage their emails, offering a more intuitive and personalized experience.

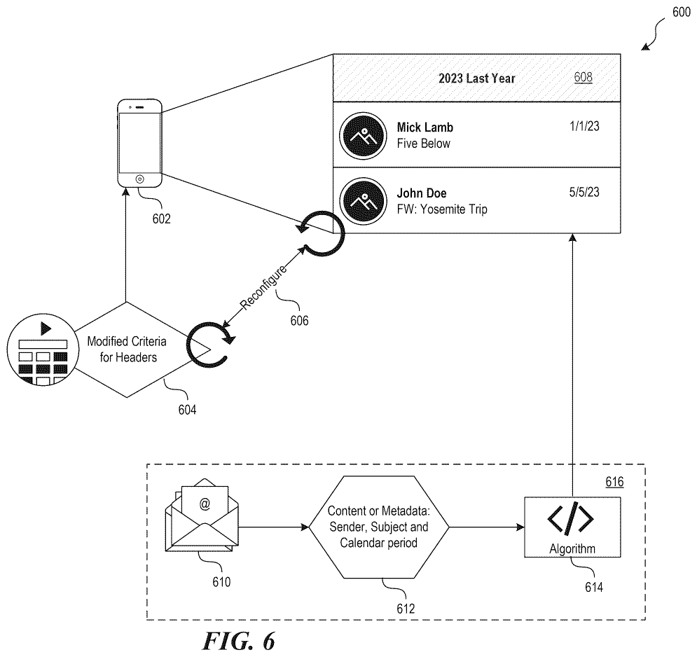

FIG. 6 illustrates a schematic representation of a system 600 for creating dynamic headers configured to organize electronic messages presented in a message client software application at a user device 602 (smartphone, tablet computer, laptop or desktop computer, etc.). The system 600 includes the user device 602 and a server 616 that contains one or more modules (e.g., software and/or hardware components) that are configured to generate dynamic headers that group the electronic messages based on user defined criteria.

A criteria-defining module 604 can configure criteria of the header 608 to dynamically separate electronic messages 610 into a group on an interface displayed on the user device 602. The criteria are defined by a user or a machine. Multiple headers (not shown) can have the same criteria with different values. The values are used to determine whether the electronic messages 610 should be grouped by the header 608 or another header. The values of the criteria can thus be the same or different across different headers on the same interface.

The electronic messages 610 are processed within the server 616. The electronic messages contain specific values assigned to various fields within the electronic message. The fields comprise but are not limited to time, calendar period, sender, subject, or any other metadata associated with the electronic messages 610.

The data-extraction module 612 is processed at the server 616. The data-extraction module 612 extracts the metadata from the electronic messages 610. The metadata of the electronic messages 610 include values for fields of each electronic message corresponding to the recipients, sender, carbon copy recipients, subject, date and time sent or received, and/or an indication of urgency. Once the criteria are configured in the criteria-defining module 604, the system 600 generates header(s) in accordance with the specified criteria values extracted via the data-extraction module 612. An algorithm 614 processes the metadata and displays the headers on the UI of the user device 602. The header(s) are assigned a value extracted from the metadata of the criterion. For example, the dynamic header 608 criteria are based on the previous calendar period of the current year that the messages were received. Therefore, the dynamic header 608 is labeled “2023 Last Year” to group all messages received in the year 2023.

The system 600 generates the dynamic header 608 with an algorithm 614 from server 616. The algorithm 614 processes the specified metadata or content from the data-extraction module 612 based on the criteria set at the criteria-defining module 604 by the user or the generative artificial intelligence. Additionally, the algorithm 614 incorporates can integrate generative AI In this case, one dynamic header 608 was generated but the generative AI has the capability to generate multiple headers and organize the electronic messages 610 into groups based on the criterion.

The system 600 allows for reconfiguring the criteria for dynamic headers. The user can reconfigure 606 the criteria to be updated to have a second value for the criteria-defining module 604, which is different from the first value. For example, the user might change the criterion to group messages received in past years instead of just the previous year. That would result in the UI of the user device 602 to display multiple dynamic headers that separate the electronic messages 610 in accordance with the newly defined calendar periods.

The components of the system 600 are illustrated at a particular device (e.g., user device 602 or server 616); however, embodiments can include components at different locations or distributed locations. For example, the data-extraction module 612 and the algorithm 614 can be located at the user device 602, or the criteria-defining module could be located at the server 616 and accessed from the user device 602. Further, embodiments could also omit certain components or add components known to skilled persons but not shown on FIG. 6 for the sake of brevity.

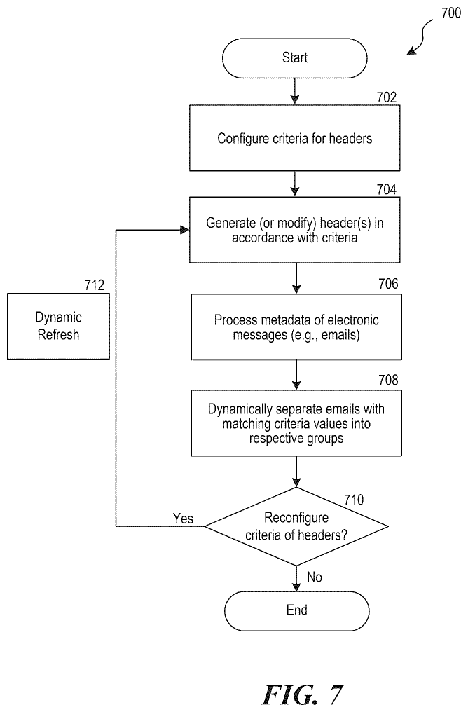

FIG. 7 is a flowchart that illustrates a process 700 for creating dynamic headers configured to organize electronic messages presented in a message client software application at a user device.

At 702, the system configures criteria for one or more headers that are configured to dynamically separate electronic messages in groups on an interface displayed on the user device. The electronic messages are separated based on whether they satisfy the criteria set by the criteria defining module. In one example, the process 700 involves receiving user input at the user device. In response to the user input, the system configures the criteria of the header(s). In one example, the criteria include setting a target value for a time parameter to a point in time or a period and setting a display format for the time parameter in the first header using a combination of day, month, and/or year or a reference relative to a current date. The system can configure multiple headers having the criteria and at least one value that differs for a particular criterion. Examples of the criteria include a timestamp when an electronic message is communicated, a source of the electronic message, and an urgency of the electronic message.

At 704, the system generates a header in accordance with the criteria. To “generate” a header can include creating a new header or updating an existing header. A newly created header can be inserted in a stack of message tiles that represent electronic messages stacked on a user interface. The header can be inserted in the stack and dynamically repositioned to regroup the electronic messages based on the criteria. In one example, a year component is changed from 2024 to 2023. In response, the system updates existing headers or adds/removes headers to reflect the change. For example, in response to changing the year criterion, the system can generate a new header for 2023 in addition to an existing header for 2024 or merely update the existing header to 2023. Then, in operation, the system can determine whether metadata of electronic messages in the stack satisfy the changed criteria and insert a header between existing headers to group electronic messages with metadata that satisfies the new criteria.

At 706, the system processes metadata of the electronic messages, including the first metadata of the first electronic message, the second metadata of a second electronic message, the third metadata of a third electronic message, and so on, all sent to a recipient associated with the user device. In one example, the first metadata and the second metadata satisfy the criterion, while the third metadata does not satisfy the criterion. The process 700 thus involves extracting values from each electronic message such as the recipients, sender, carbon copy recipients, subject, date and time sent or received, and/or an indication of urgency. The extracted values of the electronic messages are then compared to the values of the criteria for header(s). Then the process 700 at continues at 706 by assigning groups of electronic messages to respective headers having values for the criteria with matching metadata values. Additionally, the process 700 at 706 has the option the use a generative AI system to process metadata or content of the electronic messages. The processed metadata or content from the electronic messages includes the sources, dates, and times sent or received, in one example. The generative AI system dynamically generates multiple headers to organize the electronic messages into groups having specific parameter values. Examples of the metadata of the electronic messages include values for fields of each electronic message corresponding to the recipients, sender, carbon copy recipients, subject, date sent, and/or an indication of urgency.

At 708, the system dynamically inserts, repositions, or updates headers in the interface displayed on the user device. For example, the system can insert a header to separate the third electronic message from the first and second electronic messages. The user device can present graphical objects that represent the electronic messages as in a list on a user interface of the user device and insert multiple headers for multiple groups of graphical objects, where each electronic message of a corresponding graphical object belongs to one of the multiple groups with a corresponding header of the group that has criteria that matches the metadata of the electronic message. In one example, the system can cause an animation to embed the headers in a list of electronic messages, dividing the electronic messages into at least two groups. As such, a first group can satisfy the criteria values of a first header while a second group does not satisfy the criteria values the first header or satisfies the criteria values of a second header.

At 710, the system reconfigures the criteria for the one or more headers to have a second value (e.g., of the time parameter). The second value is different from the first value. As a result, the first metadata and the third metadata satisfy the criterion, while the second metadata does not satisfy the criterion. This reconfiguration ensures that the system can dynamically adapt to changing preferences set by the user or an AI system and maintain accurate data processing.

At 712, in response to the reconfigured criteria, the system dynamically modifies the location, position, or other aspect of the header(s) or associated electronic messages to separate electronic messages into respective groups. For example, the first and third electronic messages can be separated from the second electronic messages with an intervening header. In one example, the modification involves dynamically moving the first header from an initial position, which separates the third electronic message from the first and second electronic messages, to a new position that separates the second electronic message from the first and third electronic messages. Alternatively, the system may dynamically reorganize the electronic messages while keeping the position of the first header static.

In one example, the server system, equipped with at least one hardware processor and non-transitory memory, executes instructions to configure criteria of a header to dynamically separate graphical objects representing electronic messages displayed as a list on an interface. The header initially has a target value for the time parameter, and the system extracts metadata from the electronic messages, positioning the header to group messages that match this target value. When the criteria are reconfigured to a second target value, the system dynamically modifies the header, ensuring the electronic message is placed outside the group associated with the header.

The criteria can be configured and reconfigured in response to user input on the user device. The system can also generate a second header with a third target value, adding the electronic message to a new group if it matches this value. The criteria for the header can include setting the target value to a specific time or period and determining the display format using a combination of day, month, and year, or a reference relative to the current date. For user devices, including head-mounted displays, the system displays graphical objects representing electronic messages, sets criteria for headers to dynamically separate these objects, and reconfigures the criteria to adjust the grouping of messages in a mixed reality environment. The system can also animate the insertion of multiple headers to form groups of graphical objects, representing groups of electronic messages associated with respective headers that match the metadata of the messages. The dynamic modification of the header's location can involve moving it to exclude certain electronic messages from the group.

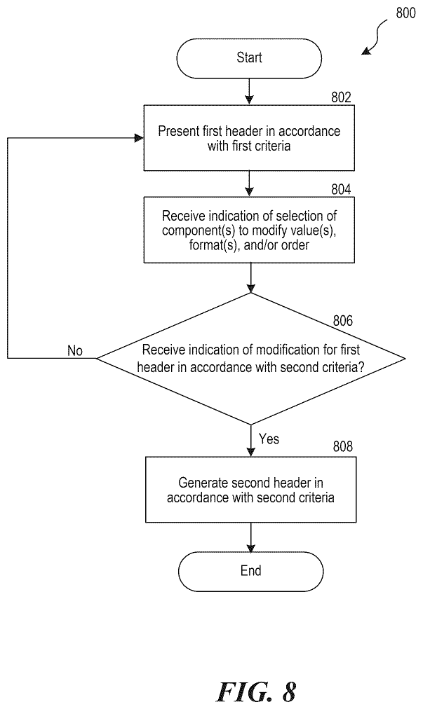

FIG. 8 is a flowchart that illustrates a process 800 for modifying a dynamic header included in a user interface of a message client software application.

At 802, the system presents the first dynamic header including one or more components that are collectively configured to satisfy a first criteria. Each component has a type and is configured to contain a specified value and have a specified format. For example, the specified value can correspond to a value for a day, month, or year of a date. The components are embedded in the first dynamic header and are presented in a specified order. As such, reordering components involves moving or removing a component. The electronic messages that satisfy the first criteria dynamically group in association with the first dynamic header.

At 804, the system receives an indication of a selection of one or more of the components to modify one or more values, formats, and/or the specified order of the first dynamic header, to satisfy a second criteria. Where the indication to change the first criteria is received from an input and/or an artificial intelligence and/or machine learning system. For example, selecting one or more of the components for modification of the first criteria is based on user input such as a touch, a mouse click, and/or a stylus pen to a user device. In response to selecting the particular component a user is presented a control such as a widget (e.g., a drop-down list, text field to input value, and/or slider bar) configured to allow the user to change the first criteria and define the second criteria to allow modifying features of components. In another example, the change in the position of the particular component is based on user input to a user device including selection (e.g., touch) and movement (e.g., drag) of the particular component from a first location to a second location of the first dynamic header. Each selected component is configured in the header in accordance with the second criteria.

At 806, the system receives an indication of a modification to the one or more values or formats of the selected components and/or the specified order of the first dynamic header. For example, a user can change a format of a particular value of a component in accordance with the second criteria. The format can be changed from a numerical format (e.g., “2023”) to a textual format (“Last Year”). In another example, the user can change the appearance (e.g., shading, color) of the area of a dynamic header. The area is defined by a boundary of the dynamic header, for example.

At 808, in response to the indication of the modification to values or formats of selected components and/or the order of the components, the system generates a second dynamic header that presents components in accordance with the second criteria. In one example, the first dynamic header is configured by the first criteria to display “Friday Jun. 14, 2024 Today.” In response to a modification, the system can generate the second dynamic header, in addition to the first dynamic header, which displays “Dec. 25, 2023 Monday Holiday.” Hence, in the example, the second dynamic header can be separate and distinct from the first dynamic header. In another example, in response to the modification, the system updates the first dynamic header in accordance with the second criteria (e.g., to present “Jun. 14, 2024 Friday”). Hence, the second dynamic header is an updated version of the first dynamic header in this example. Further, electronic messages that satisfy the second criteria can dynamically group under the second dynamic header.

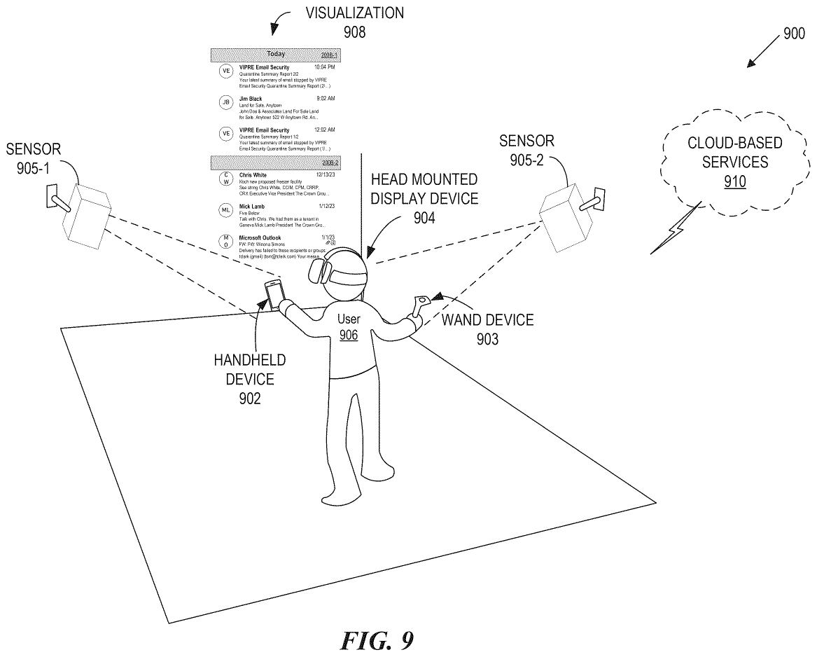

FIG. 9 illustrates a user engaged with a mixed reality system 900 for immersive message management. The components of the system 900 can include a handheld device 902 that administers a session running on other components of the system 900 including a head-mounted display (HMD) device 904 that renders a partial or full 360-degree interface. The system 900 can also include motion or position sensors 905-1 and 905-2, which are fixed in a room or worn by the user 906 such as, for example, sensors of wearables.

A near-eye display device, commonly referred to as an HMD device is an optical apparatus designed to present visual information directly in front of the user's eyes. This technology is composed of several integral components that work in unison to deliver a seamless and immersive visual experience. Central to the near-eye display device lies the optical module. The optical module includes lenses and other optical elements that project images from a micro display or similar image source directly into the user's eyes. The optical module is engineered to ensure that the images are clear, focused, and appear at a comfortable viewing distance, thereby enhancing the overall user experience.

The micro display is a small yet high-resolution display panel responsible for generating the visual content. Utilizing technologies such as Liquid Crystal Display (LCD), Organic Light Emitting Diode (OLED), Liquid Crystal on Silicon (LCoS), or Digital Light Processing (DLP), the micro display renders the images or video content that the user perceives.

Supporting these components is the frame and housing, which provides the structural integrity needed to hold the optical module and micro display in place. Designed to be lightweight and comfortable for extended wear, the frame often includes adjustable straps or other mechanisms to ensure a secure and personalized fit on the user's head.

Modern near-eye display devices are equipped with an array of sensors, including accelerometers, gyroscopes, magnetometers, and eye-tracking sensors. These sensors enable head tracking, motion detection, and gaze tracking, significantly enhancing the interactivity and immersive nature of the device. The data collected by these sensors is processed by a built-in or connected processing unit, which handles the computation required for rendering images, processing sensor data, and managing user inputs. This processing unit may be integrated into the device or connected via a wired or wireless link to an external computer or mobile device.

Connectivity interfaces such as USB, HDMI, Bluetooth, or Wi-Fi are also integral to the device, allowing it to interface with external devices, transfer data, or receive content. The power supply, typically a battery or power management system, provides the necessary energy to operate the device efficiently, supporting extended usage without frequent recharging.

User interaction with the near-eye display device is facilitated through various user interface options, including physical buttons, touchpads, voice control, or gesture recognition systems. Additionally, some devices feature integrated speakers or headphone jacks to provide audio output, further enhancing the multimedia experience.

As illustrated, the handheld device 902 operates as a wand to navigate objects of the visualization 908 experienced by the user 906 through the HMD device 904. A dedicated wand device 903 (e.g., with one or more dedicated hardware buttons) can additionally or alternatively be used for navigation. In another example, the sensors 905-1 and 905-2 can detect the position and/or movement of the user 906's finger in the air to perform the functions including the examples illustrated in FIGS. 2A through 2C, which could be rendered in a mixed reality session like on the handheld device 902.

In some embodiments, some components of the system 900 are remotely located from the user. For example, cloud components can provide cloud-based services 910 to administer the mixed-reality session running on the components of the system 900 or provide services or content for a mixed reality session. Hence, administration of a mixed reality session could be through the HMD device 904, augmented with the handheld device 902, and/or with the cloud-based services 910 that receives session progress feedback (e.g., anywhere outside of room where the user is experiencing a simulation).

As shown, the HMD device 904 can provide content (e.g., visualization 908) of a mixed-reality session and process feedback from the user via the handheld device 902 to navigate the visualization 908. As shown, the HMD device 904 is a near-to-eye display system that is worn by the user 906. For example, the HMD device 904 can have a chassis and various electrical and optical components to enable an immersive experience by the user 906 wearing the HMD device 904. For example, the HMD device 904 can include a display for each of the user's eyes. The displays can render a real-world scene of a simulation for view by the user's eyes when the HMD device 904 is worn by the user. The HMD device 904 can also include a camera mounted to the chassis. The camera can capture movement of the user's pupils for physiological feedback responsive to simulated scenes being rendered. The HMD device 904 may also include a network interface enabling the handheld device 902 to communicatively couple to the HMD device 904 over a wireless connection.

In some embodiments, the HMD device 904 includes features for measuring the user's physiological activity. For example, the HMD device 904 can include components to measure the user's electrical brain activity. As such, the HMD device 904 can collect physiological data in combination with any direct input by the user. In some embodiments, the physiological data can be used to supplement the user's conscious inputs. In some embodiments, the physiological data could be used to compare against the user's conscious input.

In one example, the HMD device 904 can render a virtual immersive environment by displaying images in view of the user's eyes such that the user can only see the images (e.g., visualization 908) and see nothing of the real-world. The HMD device 904 can also render an AR environment. As such, the user can see the visualization 908 overlying on the real world while the HMD device 904 is worn by the user 906. Hence, to achieve an AR environment, the user in an augmented reality simulation has a transparent view with digital objects overlaid or superimposed on the user's real-world view.

Examples of the sensors 905-1 and 905-2 include cameras or motion detectors that are positioned proximate to the user such that the sensors 905-1 and 905-2 can obtain real-world feedback responsive to interactions with a simulated real-world scene. For example, cameras facing the user can detect the user 906's movement while the user is engaged in a simulation and provide feedback to the HMD device 904 administering the simulation. The handheld device 902 can be used by the user 906 to submit input, which can include actuating buttons for the user 906 to input data and/or accelerometers that detect spatial movement. For example, the user 906 can move the handheld device 902 to provide inputs responsive to a scene administered by the HMD device 904.

The visualization 908 is one example of many that can be rendered in a mixed-reality session. FIGS. 2A through 2C show examples of visualizations that could be rendered in a mixed reality session. The user 906 can select and move objects of the visualization 908 in a manner described with respect to FIGS. 2A through 2C. As described further below, the system 900 can include servers that are remotely located from the user 906 and can access a program administered by the HMD device 904. Further, a local software generation and distribution framework can be used to rapidly scale content. The core components and services can support complex user and session elements that can be easily managed by a service provider. As such, a platform of a mixed reality system can standardize interaction elements such as a session landing, sign-in, navigation rules, and the like. A top-level abstraction layer can support customization such as a sequence of sessions or scenes or conditional ordering of sessions or scenes. Services can include authentication, tracking, reports, user services, help services, pause and resume services, and the like.

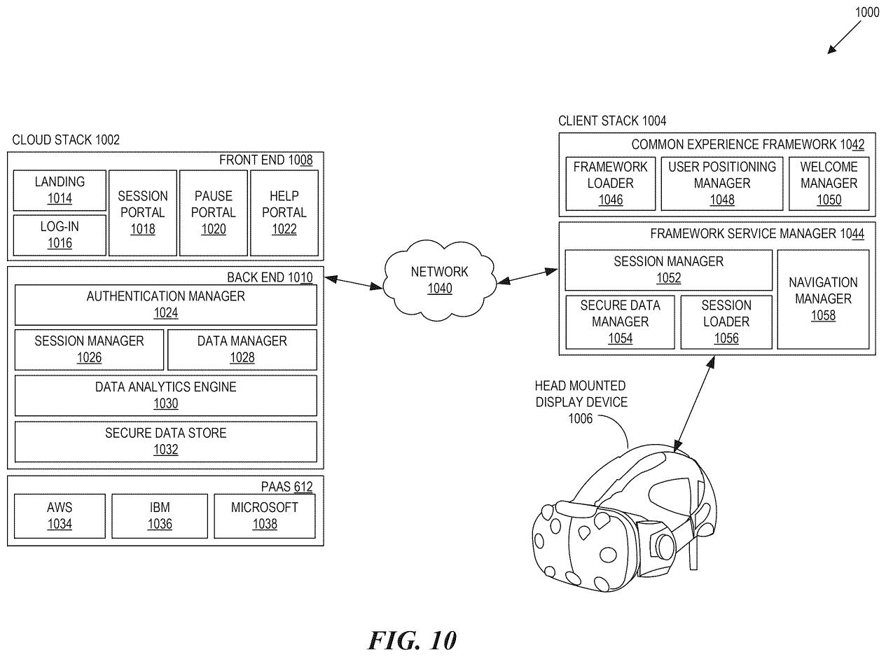

FIG. 10 is a block diagram illustrating a cloud stack 1002 and a client stack 604 architecture for a platform 1000 that can administer a mixed reality session on an HMD device 1006. As shown, the cloud stack 1002 includes three primary layers: a frontend layer 1008, a back-end layer 1010, and a platform as a service (PaaS) layer 1012. The frontend layer 1008 includes a landing component 1014 and a log-in component 616. The two components 1014 and 1016 are executed at the beginning of a session administered to orient a user and seek login credentials to control access to message programs and user information of the platform 1000. The frontend layer 1008 also includes a session portal 1018, pause portal 1020, and help portal 1022. The session portal 1018 is for normal front-facing operations of a simulation session whereas the pause portal 1020 is for operations while the session is paused. Lastly, the help portal 1022 can help the user or administrator to address questions related to the platform 1000 or simulation.

The back-end layer 1010 includes an authentication manager 1024 that can authenticate a user and/or an administrator of the platform 1000. A session manager 1026 can manage access to a particular session. A data manager 1028 can manage user data and/or data about the session such as any feedback from users while engaged in sessions. For example, the data manager 1028 can collect feedback data from multiple users including their inputs and physiological data. A data analytics engine 1030 can process the collected data to determine the actions of users and to learn how to improve the sessions (e.g., mixed reality scenes). A secure data store 1032 can store sensitive data such as data that identifies users. Lastly, the PaaS layer 1012 includes cloud computing services that provide the platform 1000 for clients to administer the mixed reality sessions. Examples include AMAZON WEB SERVICES (AWS) 1034, or services provided by IBM 1036 and/or MICROSOFT 1038.

The cloud stack 1002 is communicatively connected to the client stack 1004 over a network 1040 such as the internet. The client stack 1004 includes a common experience framework layer 1042 and a framework service manager layer 1044. The common experience framework layer 1042 includes a framework loader 1046 to load the framework for a session, a user positioning manager 1048 to monitor and track the relative position of the user engaged with the session, and a welcome manager 1050 to orient the user at the beginning of the session.

The framework service manager layer 1044 includes a session manager 1052 to manage the session experienced by a user wearing the HMD device 1006. The framework service manager layer 1044 also includes a secure data manager 1054 to store or anonymize any sensitive data, session load manager 1056 for loading a session, and a navigation manager 1058 for navigating a user through mixed reality scenes of a message management program. The platform 1000 is merely illustrative to aid the reader in understanding an embodiment. Other embodiments may include fewer or additional layers/components known to persons skilled in the art but omitted for brevity.

### Transformer

To assist in understanding the present disclosure, some concepts relevant to generative AI, including neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

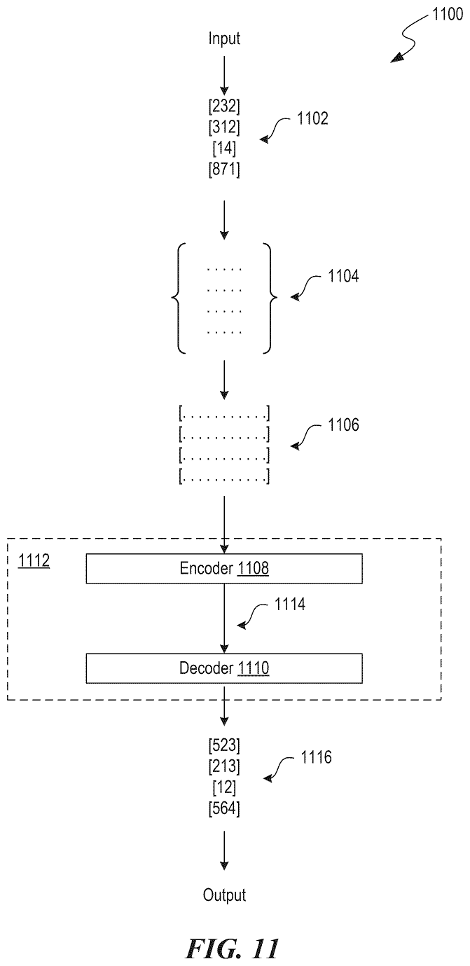

FIG. 11 is a block diagram 1100 of an example transformer 1112. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 1112 includes an encoder 1108 (which can include one or more encoder layers/blocks connected in series) and a decoder 1110 (which can include one or more decoder layers/blocks connected in series). Generally, the encoder 1108 and the decoder 1110 each include multiple neural network layers, at least one of which can be a self-attention layer. The parameters of the neural network layers can be referred to as the parameters of the language model.

The transformer 1112 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 1112 is trained to perform certain functions on other input formats than natural language input. For example, the input can include objects, images, audio content, or video content, or a combination thereof.

The transformer 1112 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 11 illustrates an example of how the transformer 1112 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 11, a short sequence of tokens 1102 corresponding to the input text is illustrated as input to the transformer 1112. Tokenization of the text sequence into the tokens 1102 can be performed by some pre-processing tokenization module such as, for example, a byte-pair encoding tokenizer (the “pre” referring to the tokenization occurring prior to the processing of the tokenized input by the LLM), which is not shown in FIG. 11 for brevity. In general, the token sequence that is inputted to the transformer 1112 can be of any length up to a maximum length defined based on the dimensions of the transformer 1112. Each token 1102 in the token sequence is converted into an embedding vector 1106 (also referred to as “embedding 1106”).

An embedding 1106 is a learned numerical representation (such as, for example, a vector) of a token that captures some semantic meaning of the text segment represented by the token 1102. The embedding 1106 represents the text segment corresponding to the token 1102 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 1106 corresponding to the “write” token will be closer to another embedding corresponding to the “jot down” token in the vector space as compared to the distance between the embedding 1106 corresponding to the “write” token and another embedding corresponding to the “summary” token.

The vector space can be defined by the dimensions and values of the embedding vectors. Various techniques can be used to convert a token 1102 to an embedding 1106. For example, another trained ML model can be used to convert the token 1102 into an embedding 1106. In particular, another trained ML model can be used to convert the token 1102 into an embedding 1106 in a way that encodes additional information into the embedding 1106 (e.g., a trained ML model can encode positional information about the position of the token 1102 in the text sequence into the embedding 1106). In some implementations, the numerical value of the token 1102 can be used to look up the corresponding embedding in an embedding matrix 1104, which can be learned during training of the transformer 1112.

The generated embeddings 1106 are input into the encoder 1108. The encoder 1108 serves to encode the embeddings 1106 into feature vectors 1114 that represent the latent features of the embeddings 1106. The encoder 1108 can encode positional information (i.e., information about the sequence of the input) in the feature vectors 1114. The feature vectors 1114 can have very high dimensionality (e.g., on the order of thousands or tens of thousands), with each element in a feature vector 1114 corresponding to a respective feature. The numerical weight of each element in a feature vector 1114 represents the importance of the corresponding feature. The space of all possible feature vectors 1114 that can be generated by the encoder 1108 can be referred to as a latent space or feature space.

Conceptually, the decoder 1110 is designed to map the features represented by the feature vectors 1114 into meaningful output, which can depend on the task that was assigned to the transformer 1112. For example, if the transformer 1112 is used for a translation task, the decoder 1110 can map the feature vectors 1114 into text output in a target language different from the language of the original tokens 1102. Generally, in a generative language model, the decoder 1110 serves to decode the feature vectors 1114 into a sequence of tokens. The decoder 1110 can generate output tokens 1116 one by one. Each output token 1116 can be fed back as input to the decoder 1110 in order to generate the next output token 1116. By feeding back the generated output and applying self-attention, the decoder 1110 can generate a sequence of output tokens 1116 that has sequential meaning (e.g., the resulting output text sequence is understandable as a sentence and obeys grammatical rules). The decoder 1110 can generate output tokens 1116 until a special [EOT] token (indicating the end of the text) is generated. The resulting sequence of output tokens 1116 can then be converted to a text sequence in post-processing. For example, each output token 1116 can be an integer number that corresponds to a vocabulary index. By looking up the text segment using the vocabulary index, the text segment corresponding to each output token 1116 can be retrieved, the text segments can be concatenated together, and the final output text sequence can be obtained.

In some implementations, the input provided to the transformer 1112 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Computer System

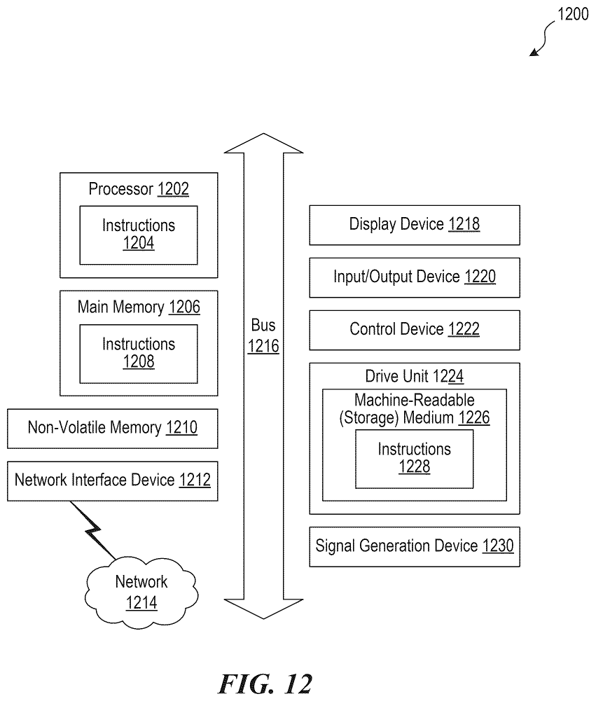

FIG. 12 is a block diagram that illustrates an example of a computer system 1200 in which at least some operations described herein can be implemented. As shown, the computer system 1200 can include: one or more processors 1202, main memory 1206, non-volatile memory 1210, a network interface device 1212, a display device 1218, an input/output device 1220, a control device 1222 (e.g., keyboard and pointing device), a drive unit 1224 that includes a machine readable (storage) medium 1226, and a signal generation device 1230 that are communicatively connected to a bus 1216. The bus 1216 represents one or more physical buses and/or point-to-point connections that are connected by appropriate bridges, adapters, or controllers. Various common components (e.g., cache memory) are omitted from FIG. 12 for brevity. Instead, the computer system 1200 is intended to illustrate a hardware device on which components illustrated or described relative to the examples of the figures and any other components described in this specification can be implemented.

The computer system 1200 can take any suitable physical form. For example, the computer system 1200 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 1200. In some implementations, the computer system 1200 can be an embedded computer system, a system-on-chip (SOC), a single-board computer (SBC) system, or a distributed system such as a mesh of computer systems or include one or more cloud components in one or more networks. Where appropriate, one or more computer systems 1200 can perform operations in real time, near real time, or in batch mode.

The network interface device 1212 enables the computer system 1200 to mediate data in a network 1214 with an entity that is external to the computer system 1200 through any communication protocol supported by the computer system 1200 and the external entity. Examples of the network interface device 1212 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 1206, non-volatile memory 1210, machine-readable medium 1226) can be local, remote, or distributed. Although shown as a single medium, the machine-readable medium 1226 can include multiple media (e.g., a centralized/distributed database and/or associated caches and servers) that store one or more sets of instructions 1228. The machine-readable medium 1226 can include any medium that is capable of storing, encoding, or carrying a set of instructions for execution by the computer system 1200. The machine-readable medium 1226 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1210, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1204, 1208, 1228) set at various times in various memory and storage devices in computing device(s). When read and executed by the processor 1202, the instruction(s) cause the computer system 1200 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A method for modifying a dynamic header included in a user interface of a message client software application, the method comprising:
presenting a first dynamic header including one or more components that are collectively configured to satisfy a first criteria,
wherein each component has a type and is configured to contain a specified value and have a specified format,
wherein the one or more components are embedded in the first dynamic header and are presented in a specified order, and
wherein one or more electronic messages dynamically group in association with the first dynamic header, in accordance with the first criteria;
receiving an indication of a selection of the one or more components to modify one or more values, formats, and/or the specified order of the first dynamic header to satisfy a second criteria,
wherein each selected component is configured in the first dynamic header in accordance with the second criteria;
receiving an indication of a modification to the one or more values or formats of the selected one or more components and/or the specified order of the first dynamic header; and
in response to the indication of the modification to the one or more values or formats of the selected one or more components and/or the specified order of the first dynamic header, generating a second dynamic header that presents components in accordance with the second criteria,
wherein one or more electronic messages dynamically group in association with the second dynamic header, in accordance with the second criteria.

2. The method of claim 1, wherein generating the second dynamic header that presents components in accordance with the second criteria comprises:
generating the second dynamic header in addition to the first dynamic header,
wherein the second dynamic header is separate and distinct from the first dynamic header.

3. The method of claim 1, wherein generating the second dynamic header that presents components in accordance with the second criteria comprises:
updating the first dynamic header in accordance with the second criteria,
wherein the second dynamic header corresponds to an updated version of the first dynamic header.

4. The method of claim 1, wherein generating the second dynamic header that presents components in accordance with the second criteria comprises:
modifying a particular value of the one or more values of the one or more components in accordance with the second criteria,
wherein the particular value corresponds to a value for a day, month, or year of a date.

5. The method of claim 1, wherein generating the second dynamic header that presents components in accordance with the second criteria comprises:
changing a format of a particular value of the one or more values of the one or more components in accordance with the second criteria,
wherein the format changes from a numerical format to a textual format.

6. The method of claim 1, wherein generating the second dynamic header that presents components in accordance with the second criteria comprises:
reordering the one or more components of the first dynamic header in accordance with the second criteria,
wherein reordering the one or more components includes moving or removing a particular component of the one or more components.

7. The method of claim 1, wherein generating the second dynamic header that presents components in accordance with the second criteria comprises:
changing an appearance to an area of the first dynamic header,
wherein the area is defined by a peripheral boundary of the first dynamic header, and
wherein the change is to a shading or color of the area.

8. The method of claim 1 further comprising:
changing a position of a particular component of the one or more components of the first dynamic header,
wherein the change in the position of the particular component is based on user input to a user device including selection and movement of the particular component from a first location to a second location of the first dynamic header, and
wherein the user input is received via touch input, a mouse click, and/or stylus pen.

9. The method of claim 1 further comprising:
selecting a particular component of one or more components of the first dynamic header; and
in response to selecting the particular component, presenting a control configured to allow a user to change the first criteria and define the second criteria.

10. The method of claim 1 further comprising:
presenting different widgets including a drop-down list, text field to input value, and/or slider bar configured to allow modifying values of the one or more components.

11. The method of claim 1, wherein the indication to change the first criteria is received from an input and/or an artificial intelligence and/or machine learning system.

12. A system for modifying a dynamic header included in a user interface of a message client software application, the system comprising:
at least one hardware processors; and
at least non-transitory memory storing instructions, which, when executed by the at least one hardware processors, cause the system to:
present a first dynamic header including one or more components that are collectively configured to satisfy a first criteria,
wherein each component has a type and is configured to contain a specified value and have a specified format,
wherein the one or more components are embedded in the first dynamic header and are presented in a specified order, and
wherein one or more electronic messages dynamically group in association with the first dynamic header, in accordance with the first criteria;
receive an indication of a selection of the one or more components to modify one or more values, formats, and/or the specified order of the first dynamic header to satisfy a second criteria,
wherein each selected component is configured in the first dynamic header in accordance with the second criteria;
receive an indication of a modification to the one or more values or formats of the selected one or more components and/or the specified order of the first dynamic header; and
in response to the indication of the modification to the one or more values or formats of the selected one or more components and/or the specified order of the first dynamic header, generate a second dynamic header that presents components in accordance with the second criteria,
wherein one or more electronic messages dynamically group in association with the second dynamic header, in accordance with the second criteria.

13. The system of claim 12, where the system is further instructed to:
generate the second dynamic header in addition to the first dynamic header,
wherein the second dynamic header is separate and distinct from the first dynamic header.

14. The system of claim 12, where the system is further instructed to:
update the first dynamic header in accordance with the second criteria,
wherein the second dynamic header corresponds to an updated version of the first dynamic header.

15. The system of claim 12, where the system is further instructed to:
modify a particular value of the one or more values of the one or more components in accordance with the second criteria,
wherein the particular value corresponds to a value for a day, month, or year of a date.

16. The system of claim 12, where the system is further instructed to:
change a format of a particular value of the one or more values of the one or more components in accordance with the second criteria,
wherein the format changes from a numerical format to a textual format.

17. A non-transitory, computer-readable storage medium comprising instructions recorded thereon, wherein the instructions, when executed by at least one data processor of a system, cause the system to:
present a first dynamic header including one or more components that are collectively configured to satisfy a first criteria,
wherein each component has a type and is configured to contain a specified value and have a specified format,
wherein the one or more components are embedded in the first dynamic header and are presented in a specified order, and
wherein one or more electronic messages dynamically group in association with the first dynamic header, in accordance with the first criteria;
receive an indication of a selection of the one or more components to modify one or more values, formats, and/or the specified order of the first dynamic header to satisfy a second criteria,
wherein each selected component is configured in the first dynamic header in accordance with the second criteria;
receive an indication of a modification to the one or more values or formats of the selected one or more components and/or the specified order of the first dynamic header; and
in response to the indication of the modification to the one or more values or formats of the selected one or more components and/or the specified order of the first dynamic header, generate a second dynamic header that presents components in accordance with the second criteria,
wherein one or more electronic messages dynamically group in association with the second dynamic header, in accordance with the second criteria.

18. The non-transitory, computer-readable storage medium of claim 17, wherein the system is further caused to:
change a position of a particular component of the one or more components of the first dynamic header,
wherein the change in the position of the particular component is based on user input to a user device including selection and movement of the particular component from a first location to a second location of the first dynamic header, and
wherein the user input is received via touch input, a mouse click, and/or stylus pen.

19. The non-transitory, computer-readable storage medium of claim 17, wherein the system is further caused to:
select a particular component of one or more components of the first dynamic header; and
in response to selecting the particular component, present a control configured to allow a user to change the first criteria and define the second criteria.

20. The non-transitory, computer-readable storage medium of claim 17, wherein the system is further caused to:
present different widgets including a drop-down list, text field to input value, and/or slider bar configured to allow modifying values of the one or more components.
